(19) United States
(12) Patent Application Publication
(10) Pub. No.: US 2026/0229725 A1
(43) Pub. Date: Aug. 6, 2026

(54) CONNECTION PART INTENDED FOR ELECTRICALLY CONNECTING A FIRST METAL SURFACE TO A SECOND METAL SURFACE IN AN ELECTROCHEMICAL GENERATOR, ASSOCIATED GENERATOR AND ASSOCIATED METHOD

(71) Applicant: SAFT, LEVALLOIS PERRET (FR)

(72) Inventors: Gérard RIGOBERT, FARGUES ST HILAIRE (FR); Alexandre BEUGNON, LE PIAN MEDOC (FR)

(73) Assignee: SAFT, LEVALLOIS PERRET (FR)

(21) Appl. No.: 19/149,500

(22) PCT Filed: Jan. 18, 2024
(86) PCT No.: PCT/EP2024/051190

§ 371 Date: Jul. 18, 2025

(30) Foreign Application Priority Data
Jan. 19, 2023 (FR) FR2300515

(51) Int. Cl. H01M 50/536; H01M 10/052; H01M 50/534

(52) U.S. Cl. CPC H01M 50/536; H01M 10/052; H01M 50/534

(57) ABSTRACT

A connection part includes a metal body with a first electrical connection part connected to a first metal surface and a second electrical connection part connected to a second metal surface. At least one of the first electrical connection part and the second electrical connection part has a fixing face intended to be welded respectively to the first metal surface or to the second metal surface and an opposite face for applying welding power. The opposite face for applying welding power having a rough region. The rough region having a roughness Ra greater than 10 μm.

### CROSS REFERENCE TO RELATED APPLICATIONS

The present application is a U.S. National Phase Application under 35 U.S.C. § 371 of International Patent Application No. PCT/EP2024/051190 filed Jan. 18, 2024, which claims priority of French Patent Application No. 2300515 filed Jan. 19, 2023. The entire contents of which are hereby incorporated by reference.

### FIELD

The present invention relates to a connection part intended for electrically connecting a first metal surface to a second metal surface in an electrochemical generator, the connection part comprising a metal body having a first electrical connection part, to be connected to the first metal surface and a second electrical connection part, to be connected to the second metal surface, at least one of the first electrical connection part and the second electrical connection part having an attachment face intended to be welded respectively to the first metal surface or to the second metal surface and an opposite face for applying welding power, the opposite face for applying welding power having a rough region.

### BACKGROUND

Such an electrical connection part is intended to be fixed, notably by laser welding by transparency between two parts in an electrochemical generator, for example a lithium-ion accumulator.

The connection part is notably intended to be welded to metal surfaces made of copper, aluminum, or stainless steel of connection elements, such as a tab and/or an electrode strip of an electrochemical bundle, an output terminal, a busbar, a lug, etc.

During laser welding by transparency, part of the laser beam is reflected and does not contribute to the welding energy. For example, with the use of an infrared wavelength (approximately 1070 nm), only about 5% of the laser beam energy for copper and 10% of the laser beam energy for aluminum is actually transmitted to the material to be welded to initiate the melt pool.

Moreover, depending on the surface condition variabilities of the materials, delivery conditions, and different production batches, the absorption percentage is also variable. These variations in brightness are likely to cause heterogeneous welding performances between different batches. The welding parameters must be adapted depending on the different material states to obtain a compliant weld.

To address this problem, the welding energy supplied to this part is significantly increased and can be at the maximum technical limits of the laser (notably in terms of power), leaving no room for adjustment in the welding process.

Furthermore, the risk of burning peripheral parts remains significant due to the high energy required.

A solution to this problem consists, according to EP 3 073 551, of making regularly spaced impressions, for example in the shape of an inverted pyramid, according to two directions located in a plane defined by the surface on which the laser is applied.

This document also describes, for comparison, welds that are made on low roughness regions and are defective.

The creation of periodic patterns very significantly reduces the reflections occurring on the surface, and thus greatly increases the absorptivity of the treated material.

Thus, the weld bead can be made without having to operate the laser near its technical limits, and without burning the peripheral parts.

Such a connection part can still be improved, notably to simplify the manufacturing method and reduce the probability of having untreated zones.

### SUMMARY

An aim of the invention is to provide an electrical connection part that can be robustly welded between two metal surfaces of an electrochemical generator, without applying too high laser power, while simplifying the realization of the part.

To this end, the subject matter of the invention is a connection part of the aforementioned type, characterized in that the rough region has a roughness Ra greater than 10 micrometers according to the National French European International standard (NF EN ISO) 21920-3.

The connection part according to the invention may comprise one or more of the following features, taken alone or in any technically possible combination:
the rough region has a roughness Ra greater than 20 micrometers, according to the standard NF EN ISO 21920-3;
the rough region has a roughness Ra less than 50 micrometers, notably less than 40 micrometers according to the standard NF EN ISO 21920-3;
the rough region includes less than 5% in total surface of flat zones;
the rough region is devoid of flat zones;
the rough region includes irregular roughness;
the metal body is made of copper, aluminum, or stainless steel;
the thickness of the metal body is less than 2 mm and notably comprised between 200 μm and 2 mm.

The subject matter of the invention is also an electrochemical generator, comprising:
a first metal surface;
a second metal surface;
a connection part such as defined above, electrically connecting the first metal surface to the second metal surface, the connection face being welded on at least one of the first metal surface and the second metal surface.

The electrochemical generator according to the invention may comprise one or more of the following features, taken alone or in any technically possible combination:
the first metal surface is defined on an electrical output power terminal; the second metal surface being defined in an electrochemical bundle including at least one electrode;
the electrode of the electrochemical bundle includes a strip; the connection part being connected to the strip;
the electrochemical generator is of the lithium-ion type.

The subject matter of the invention is also a method of connecting a first metal surface to a second metal surface in an electrochemical generator, the method including the following steps:
providing a connection part comprising a metal body having a first electrical connection part to be connected to the first metal surface and a second electrical connection part to be connected to the second metal surface, at least one of the first electrical connection part and the second electrical connection part having a connection face intended to be welded respectively to the first metal surface or to the second metal surface and an opposite face for applying welding power, the opposite face for applying welding power having a rough region, the rough region having a roughness Ra greater than 10 μm according to the standard NF EN ISO 21920-3;
applying welding power on the opposite face to carry out the weld between the first metal surface and/or the second metal surface and the connection part.

The method according to the invention may comprise one or more of the following features, taken alone or in any technically possible combination:
the application of welding power is carried out by emitting a laser beam directed onto the rough region;
the method includes a preliminary step of forming the rough region, by stamping, by laser treatment, by ultrasonic treatment, and/or by chemical attack.

### BRIEF DESCRIPTION OF THE DRAWINGS

Further features and advantages of the invention will become more apparent from the description, which is illustrated by way of non-limiting example in the drawings, which:

FIG. 1 is a simplified sectional view of an electrochemical generator including a first metal connection part according to the invention, connecting an electrochemical bundle of the coil type to an output terminal;

FIG. 2 is a photograph illustrating a rough region with a roughness Ra greater than 10 μm for a connection part according to the invention, made of copper;

FIG. 3 is a view similar to FIG. 2, the connection part being made of aluminum;

FIG. 4 is a schematic sectional view of a laser welding step in a connection method of the connection part according to the invention; and

FIG. 5 is a view similar to FIG. 1 of the connection part between a tab of an electrochemical bundle of a prismatic cell and a terminal of the prismatic cell.

### DETAILED DESCRIPTION

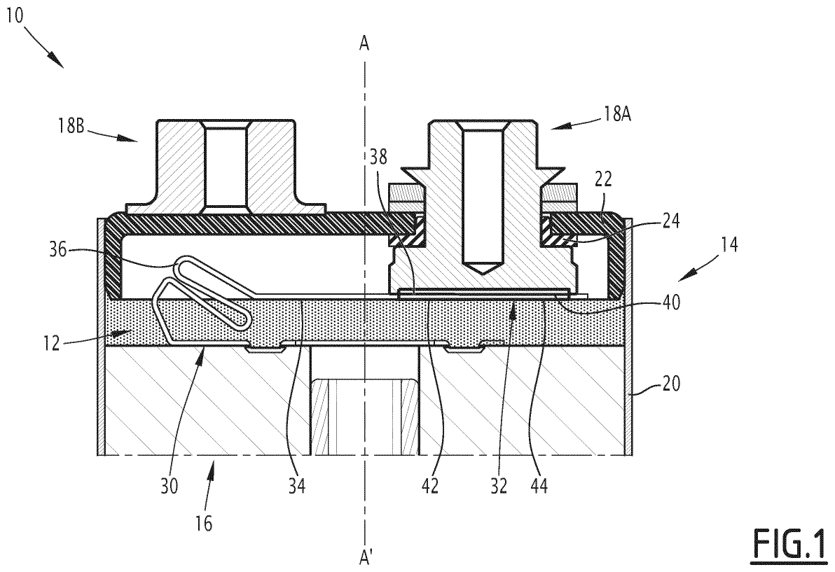

A first electrochemical generator 10 according to the invention, equipped with a connection part 12 according to the invention is schematically represented in FIG. 1.

In this example, the electrochemical generator 10 includes at least one electrochemical cell or element 14 which, in the example of FIG. 1, is a cylindrical cell.

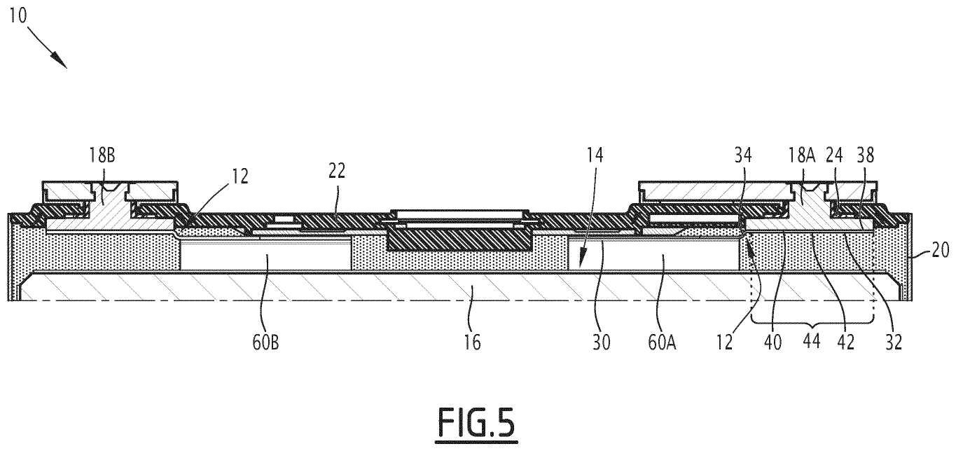

Alternatively, as will be described later with reference to FIG. 5, the electrochemical cell 14 is a prismatic cell, or a pouch.

The electrochemical cell 14 is for example of the lithium-ion type.

The electrochemical cell 14 includes, in the example of FIG. 1, a bundle 16 of electrodes of opposite polarities.

The electrode bundle 16 includes an alternation of electrodes of a first polarity, for example positive, and electrodes of a second polarity, for example negative, and a separator, separating each pair of electrodes of opposite polarities facing each other.

In this example, the electrode bundle 16 is wound around a central axis A-A′ and forms a coil.

Advantageously, the electrochemical cell 14 further includes a container 20 containing the electrode bundle 16 and the connection part 12, and a cover 22, closing the container 20.

The electrochemical cell 14 further includes terminals 18A, 18B carried by the cover 22.

The terminals 18A, 18B are output terminals to provide electrical power when the electrochemical generator 10 discharges, and to receive electrical power, when the electrochemical generator is being charged.

Advantageously, the terminal 18A is connected to the or each electrode of the first polarity and the terminal 18B is connected to the or each electrode of the second polarity.

In this example, the first polarity terminal 18A is mounted through the cover 22 while being electrically isolated from it by a seal 24. The terminal 18A is connected to the electrode bundle 16 by means of a connection part 12 according to the invention.

The second polarity electrode 18B is directly mounted on the cover 22, being in electrical contact with the cover 22. The second polarity electrode is electrically connected to the second polarity terminal 18B by means of the container 20 and the cover 22.

The connection part 12 extends here between a first metal surface present on the terminal 18A and a second metal surface present in the bundle 16. It extends in particular between one or more electrodes of the first polarity of the bundle 16, and a metal surface of the terminal 18A.

The connection part 12 has a first electrical connection part 30 connected to the bundle 16, welded to the bundle 16 and a second electrical connection part 32 connected to the terminal 18A, welded to the terminal 18A.

The connection part 12 is preferably made in the form of a thin metal body, in particular, the form of a metal strip 34.

The metal strip 34 is for example made of copper or a copper alloy. Examples of materials forming the metal strip 34 are Cua1 type copper (Cu-ETP) having 99.9% minimum mass of copper, Cub1 type copper (Cu-DHP), having 99.9% minimum mass of copper, with a residual presence of phosphorus, or Cuc1 type copper (CU-OF), which is deoxidized, and which has 99.95% minimum mass of copper.

Alternatively, the metal strip 34 is made of aluminum, or an aluminum alloy or stainless steel.

The thickness of the metal strip 34 is for example less than 2 mm and is notably comprised between 200 μm and 2 mm, preferably between 300 μm and 600 μm.

In the example represented in FIG. 1, the metal strip 34 is folded. It has here an intermediate part 36 defining a plurality of successive folds.

In its second part 32, the metal strip 34 includes a connection face 38 welded to a corresponding metal surface 40 of the terminal 18A.

The metal strip 34 further has, in its second part 32 opposite the connection face 38, a face 42 for applying welding power.

As will be seen below, the application face 42 is intended, after application of the connection face 38 on the metal surface 40, to receive welding power, for example by being illuminated by a laser beam 50 providing welding light power. The application face 42 thus receives the welding power from an external source, this power then being transmitted through the metal strip 34 to the connection face 38 and into the metal surface 40.

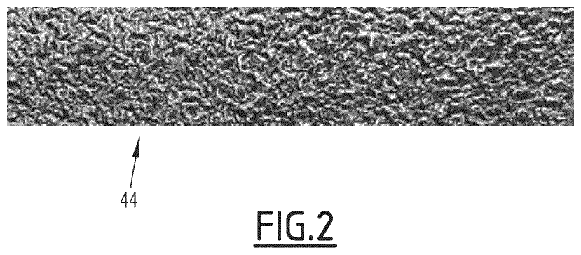

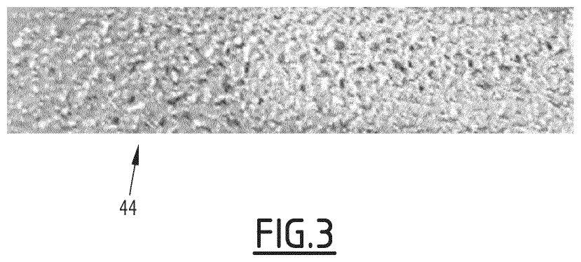

The application face 42 includes a rough region 44, an example of which is illustrated in FIG. 2 for a metal strip 34 in copper and another example is illustrated in FIG. 3 for a metal strip 34 in aluminum.

The second part 32 of the metal strip 34 is fixed on the receiving surface 40 by a weld bead 46 linking the connection face 38 and the receiving surface 40. The weld bead 46 is made by melting metal from the metal strip 34 and the terminal 18A in a contact zone and by solidifying the contact zone.

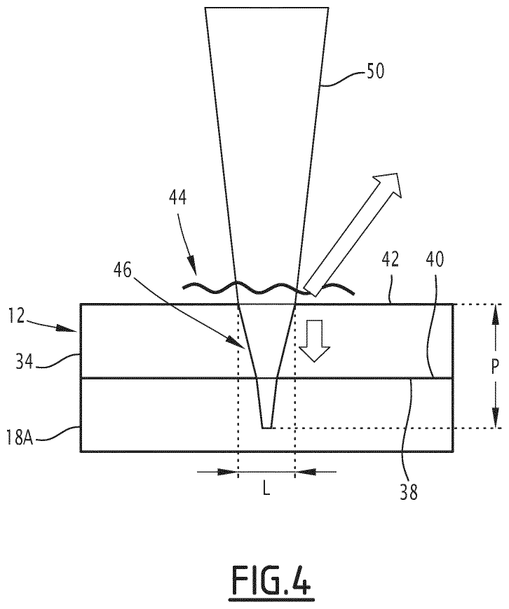

As illustrated by FIG. 4, the obtained weld bead 40 is advantageously reduced in width L relative to its depth P.

As visible in FIG. 2, the rough region 44 is formed of an irregular alternation of hollows and bumps.

According to the invention, the rough region has a roughness Ra, greater than 20 μm, as measured by the Standard NF EN ISO 21920-3 of January 2022 (which cancels and replaces the Standard NF EN ISO 4288 of March 1998).

The roughness Ra is defined as the arithmetic mean roughness, which is the arithmetic mean of the deviations from the mean line, over a maximum measurement length, as defined in the standard NF EN ISO 21920-3.

Preferably, the rough region has a roughness Ra less than 50 μm, notably less than 40 μm.

The rough region 44 preferably includes less than 5% in total surface of flat areas. In particular, as illustrated in FIG. 2, the rough region 44 is completely devoid of flat areas.

The roughness of the rough region 44 is irregular and random. Thus, the hollows and bumps have different direction, extent, and contour shapes, and are not periodic.

Surprisingly, the use of such roughness, possibly irregular, and/or associated with an absence of a flat zone in the rough region 44, favorably modifies the surface condition of the face 42 at the point where the welding power is applied.

This modification significantly increases the percentage of light power absorbed by the application face 42 when a laser beam 50 is directed on the rough region 44, which increases the energy transmitted to the weld pool.

Thus, the power of the laser beam 50 can be reduced for the realization of a very robust weld bead 46, allowing the laser beam 50, not to work at the maximum emission power, while avoiding damaging the adjacent or neighboring regions to the rough region 44.

The roughness extends only in the rough region 44 on the application face 42, while maintaining a connection face 38 devoid of macroscopic roughness to optimize contact with the metal surface 40. In addition, the reliefs formed on the application face 42 do not protrude relative to the periphery of the rough region 44.

Such a surface treatment therefore allows a significant reduction in the welding energy required for a compliant weld and therefore less heating of the surrounding parts, as well as a greater margin for adjusting the laser beam parameters. This ensures better stability of the welding method of the connection part 12.

Preferably, the rough region 44 is formed by mechanical stamping, for example with a punch itself provided with a shape conjugated to that of the rough region 44.

In an advantageous alternative, the connection part 12 is also made by stamping. In this case, the punch allowing to obtain the roughness of the rough region 44 is preferably integrated on the stamping tool of the connection part 12 allowing the shaping of the contour of the connection part 12. This allows to obtain better welding quality, without affecting the price of the part.

Alternatively, the stamping of the rough region 44 is carried out upstream of the actual stamping of the connection part 12, for example during the rolling of a metal strip intended to form the connection part 12 or during the unwinding of the metal strip before stamping.

Alternatively, the rough region 44 is formed by laser or ultrasonic treatment, or by chemical attack.

An electrical connection method of a first metal surface to a second metal surface of the electrochemical generator 10, by means of a connection part 12 according to the invention, will now be described.

In this example, the first metal surface is defined on the terminal 18A, the second metal surface being defined in the bundle 16.

Initially, the connection part 12 is supplied. This supply step comprises, for example, the provision of a metal strip 34 devoid of a rough region 44, and the formation of a rough region 44 by mechanical stamping, for example using a punch having a shape conjugated to that of the desired roughness.

Alternatively, the rough region 44 is formed by laser or ultrasonic treatment, or by chemical attack.

Once this is done, the connection face 38 is applied to the metal surface 40 on which it is to be welded. The rough region 44 is placed facing the zone of the metal surface 40 in which the weld bead 46 is to be realized.

As illustrated by FIG. 4, a laser beam 50 is brought in front of the rough region 44. The laser beam 50 is directed at and focused on the rough region.

The laser beam 50 advantageously emits infrared light, notably at a wavelength comprised between 900 nm and 1200 nm, preferably between 1050 nm and 1100 nm.

The laser beam 50 is for example provided by a Nd: YAG laser (neodymium-doped yttrium-aluminum garnet).

By means of the particular roughness of the rough region 44, the reflection of the laser beam 50 on the application face 38 is reduced, and the absorption of the energy of the laser beam 50 through the metal strip 34 and the metal surface 40 is increased.

Thus, a weld pool forms through the entire thickness of the metal strip 34, and partially through the metal surface 40 on which the metal strip 34 is to be welded. The weld pool brings into contact molten metal from the metal strip 34 with molten metal from the metal surface 40.

When the weld pool cools, a solid weld bead 46 is thus made.

The particular roughness used at the application face 42 surprisingly leads to an increase in the energy absorbed within the metal strip 34, and beyond, to the part on which the metal strip 34 is to be welded.

Thus, the weld between the metal strip 34 and the part on which it is fixed is particularly robust.

The adjacent surfaces and/or in the neighborhood of the rough region 44 are not significantly subjected to the power of the laser beam 50, which avoids their damage.

It is therefore not necessary to use the laser at its maximum power, and the part is made very simply.

In one alternative, illustrated by FIG. 5, the electrochemical cell 14 is a prismatic cell. The electrode bundle 16 includes a stack of flat electrodes having electrical connection tabs 60A, 60B. The tabs 60A of the first polarity electrodes are preferably grouped on one side of the prismatic cell, while the tabs 60B of the second polarity electrodes are grouped on another side of the prismatic cell.

In this example, a connection part 12 connects each group of tabs 60A, 60B to a respective terminal 18A, 18B.

As previously described, on the connection part 12, the connection face 38, at a metal surface 40 of the terminal 18A is provided with a rough region 44 having a roughness Ra, greater than 20 μm according to the standard NF EN ISO 21920-3.

In another alternative, the connection part 12 connects other metal parts within the electrochemical generator 10, for example busbars, a lug, or even connects two metal surfaces within the same part of the electrochemical generator 10.

In one alternative, not represented, of the previous embodiments, the first electrical connection part 30 is connected to the first metal surface and the second electrical connection part 32 is connected to the second metal surface, each has a connection face 38, welded respectively to the first metal surface and to the second metal surface and an opposite face 42 for applying welding power having a rough region 44.

As previously described, the rough region 44 has a roughness Ra greater than 10 μm according to the standard NF EN ISO 21920-3.

This is particularly the case for the weld between the first part 30 and the electrode bundle 16.

1. A connection part to electrically connect a first metal surface to a second metal surface in an electrochemical generator, the connection part comprising a metal body having a first electrical connection part to be connected to the first metal surface and a second electrical connection part to be connected to the second metal surface, at least one of the first electrical connection part and the second electrical connection part having a connection face to be welded respectively to the first metal surface or to the second metal surface and an opposite face to apply welding power, the opposite face having a rough region,
the rough region having a roughness Ra greater than 10 μm according to standard NF EN ISO 21920-3.

2. The connection part according to claim 1, wherein the rough region has a roughness Ra greater than 20 μm, according to the standard NF EN ISO 21920-3.

3. The connection part according to claim 1, wherein the rough region has a roughness Ra less than 50 μm according to the standard NF EN ISO 21920-3.

4. The connection part according to claim 1, wherein the rough region includes less than 5% in total surface of flat zones.

5. The connection part according to claim 4, wherein the rough region is devoid of flat zones.

6. The connection part according to claim 1, wherein the rough region includes irregular roughness.

7. The connection part according to claim 1, wherein the metal body is made of copper, aluminum, or stainless steel.

8. The connection part according to claim 1, wherein the thickness of the metal body is less than 2 mm.

9. An electrochemical generator, comprising:
a first metal surface;
a second metal surface;
a connection part according to claim 1, electrically connecting the first metal surface to the second metal surface, the connection face being welded on at least one of the first metal surface and the second metal surface.

10. The electrochemical generator according to claim 9, wherein the first metal surface is defined on an output electrical power terminal, the second metal surface being defined in an electrochemical bundle including at least one electrode.

11. The electrochemical generator according to claim 10, wherein the at least one electrode of the electrochemical bundle includes a strip, the connection part being connected to the strip.

12. The electrochemical generator according to claim 9, wherein the electrochemical generator is a lithium-ion electrochemical generator.

13. A method of connecting a first metal surface to a second metal surface in an electrochemical generator, the method including:
providing a connection part comprising a metal body with a first electrical connection part to be connected to the first metal surface and a second electrical connection part to be connected to the second metal surface, at least one of the first electrical connection part and the second electrical connection part having a connection face intended to be welded respectively to the first metal surface or to the second metal surface and an opposite face to apply welding power, the opposite face having a rough region, the rough region having a roughness Ra greater than 10 μm according to standard NF EN ISO 21920-3; and
applying welding power on the opposite face to carry out the weld between the first metal surface and/or the second metal surface and the connection part.

14. The method according to claim 13, wherein applying welding power comprises emitting a laser beam directed on the rough region.

15. The method according to claim 13, preliminary forming the rough region, by stamping, by laser treatment, by ultrasonic treatment, and/or by chemical attack.

16. The connection part according to claim 3, wherein the rough region has a roughness Ra less than 40 μm, according to the standard NF EN ISO 21920-3.

17. The connection part according to claim 8, wherein the thickness of the metal body is between 200 μm and 2 mm.
